(19) United States
(12) Patent Application Publication
(10) Pub. No.: US 2025/0201811 A1
(43) Pub. Date: Jun. 19, 2025

(54) N-DOPED SODIOPHILIC CARBON ANODE FROM POLYMER FOR SODIUM BATTERIES

(71) Applicant: COUNCIL OF SCIENTIFIC & INDUSTRIAL RESEARCH, New Delhi (IN)

(72) Inventors: Manjusha Vilas SHELKE, Pune (IN); Poonam YADAV, Pune (IN)

(73) Assignee: COUNCIL OF SCIENTIFIC & INDUSTRIAL RESEARCH, New Delhi (IN)

(21) Appl. No.: 18/849,859

(22) PCT Filed: Mar. 28, 2023
(86) PCT No.: PCT/IN2023/050293

§ 371 Date: Sep. 23, 2024

(30) Foreign Application Priority Data
Mar. 28, 2022 (IN) 202211018197

(51) Int. Cl. H01M 4/1393; B09B 3/35; B09B 3/40; B09B 101/75; H01M 4/02; H01M 4/04; H01M 4/133; H01M 4/58; H01M 4/587; H01M 10/054; H01M 10/0567; H01M 10/0568; H01M 10/0569; H01M 50/431; H01M 50/44

(52) U.S. Cl. CPC H01M 4/1393; B09B 3/35; B09B 3/40; H01M 4/0402; H01M 4/0419; H01M 4/133; H01M 4/5825; H01M 4/587; H01M 10/054; H01M 10/0567; H01M 10/0568; H01M 10/0569; H01M 50/431; H01M 50/44; B09B 2101/75; H01M 2004/021; H01M 2004/027

(57) ABSTRACT

The present invention discloses a biphasic Nitrogen doped sodiophilic anode. The present disclosure also provides a process of preparing a defect rich Nitrogen doped waste polymer derived carbon (PDC) and commercial polyvinyl based polymer derived carbon (PRC) as carbon precursor for use in sodium ion/metal battery with high capacity, long cyclic stability in both half cell and full cell.

### FIELD OF THE INVENTION

The present invention relates to a biphasic Nitrogen doped sodiophilic anode for sodium ion/metal batteries. In particular, the present invention provides a sustainable approach to obtain carbon based sodiophilic material which is defect rich and N-doped from recycling of polymer waste and/or commercial polyvinyl based polymers as carbon precursor for use in sodium ion/metal battery with high capacity, long cyclic stability in both half cell and full cell. The invention finds immense application in the field of batteries for use in electric vehicles. It shall also help attain the 7th sustainable development goal of affordable and clean energy.

### BACKGROUND OF THE INVENTION

Development of high performance, low cost, and environmentally friendly electrode materials is required for batteries considering the increasing demand for electronics, electric vehicles, and decreasing non-renewable energy resources. Li-ion batteries (LIB) are electrochemically promising but they have several limitations. As an alternative to LIB, Na-ion battery (NIB) and Na metal batteries (NMB) are acquiring research and industrial attention especially for grid storage. attributable to similar electrochemistry to LIB, high abundance, low cost, better safety, less polarizability, better rate kinetics, less intercalation potential of Na on the anode side, and less irreversible capacity loss in anode materials. However, large scale adoption of Na metal anode (NMA) is hindered by challenges for instance (i) inhomogeneous Na flux and deposition, (ii) dendrite growth, (iii) severe volume change, (iv) unstable solid electrolyte interphase (SEI) due to high reactivity of Na, and (vi) safety hazards.

Various strategies have been investigated to control the Na plating/stripping such as (i) artificial SEI (ii) modulating electrolyte composition (iii) Na composite anode with sodiophilic seeds (iv) engineered sodiophilic host and (v) solid-state electrolyte. Among engineered hosts, carbon host is promising for Na plating/stripping due to high conductivity, high mechanical strength, alleviation of Na volume change and tunable morphology. Besides having several advantages, carbon hosts such as 3D foam and porous templates involve complicated synthesis steps.

Bio-mass is low cost, abundant and scalable choice of precursor for disordered carbon synthesis. But due to discrepancies in the composition of biomass, there can be a huge difference in the electrochemical performance from batch to batch. Hard carbon synthesized from biomass such as sucrose and pitch is reported to exhibit capacity of 225-400mAhg⁻¹ [Yu et. al J. Energy Chem. 2021, 55, 499-508; Kim et. al. J. Phys. Chem. C 2021, 125, 27, 14559-14566]. Thus, the need exists in the art for carbon anode which is cost effective, is highly disordered, provides tuned pore volume to control irreversible coulombic efficiency (ICE), has large interlayer spacing, and high conductivity or graphitization.

Judicious selection of carbon precursor as well as dopant is the key factor to overcome above mentioned inconsistencies in carbon anode. The use of polymer precursors such as PAN derived carbon fibers is reported which exhibits 240 mAhg⁻¹ capacity at 100 mAg⁻¹ [Chen et. al., J. Mater. Chem. A, 2017, 5, 19866-19874] and PVC have also been utilized and has demonstrated capacity of 215 mAhg⁻¹ at 12 mAg⁻¹ [Bai et. al., ACS appl. Mater. Interfaces, 2015, 7, 5598-5604]. In NMBs, engineered carbon-based materials such as S-CNT, VG/CC, 3DrGO/CNT, TiC₂Tx-rGO, carbon microspheres, carbon nanofibers and paper derived carbon have been studied. But their electrochemical performance is poor in term of overpotential, coulombic efficiency and stability.

Polymer precursors have the potential to make invariable and high charge storage carbon materials for NIB and NMB. Recycling or carbonization of the used/waste polymer material could be added advantage for turning waste into new potentially useful anode material. Amorphous carbon chips li-ion battery anodes produced through polyethylene waste upcycling is reported. [Villagómez-Salas et. al., ACS Omega, 2018, 3, 17520-17527]. The solvothermal approach to effectively react sulfuric acid on polyethylene (PE) chains, modifying the PE at a moderate temperature, the polymer undergoes a cross-linking step above 120° C., whereas above 500° C., it transforms into turbostratic carbon structures, is also reported.

Yan et al. [Frontiers in Chem, 2019, 7, 1-11] discloses lithium metal is deemed as an ideal anode material for next-generation lithium ion batteries (LIBs) due to its high specific capacity and low redox potential. A vertical graphene nanosheet grown on carbon cloth (VG/CC) synthesized is adopted as the Li deposition host. The three-dimensional VG/CC with a large surface area can provide abundant active nucleation sites and effectively reduce the current density, leading to homogeneous Li deposition to overcome the dendrite issue. The Li@VG/CC anode exhibits a dendrite-free morphology after a long cycle and superior electrochemical performance to that of planar Cu current collector. It delivers a small voltage hysteresis of 90.9 mV at a high current density of 10 mA cm⁻² and a Coulombic efficiency of 99% over 100 cycles at 2 mA cm⁻².

Yan et al. [J. Mater. Chem. A, 2020, 8, 19843-19854] discloses an artificial reduced graphene oxide/carbon nanotube (rGO/CNT) microlattice aerogel was constructed by a three-dimension (3D) printing technology and further adopted as sodium metal host. The Na@rGO/CNT microlattice anode enables an areal capacity of 1 mAh cm⁻² at 2 mA cm⁻² with a small nucleation overpotential of 17.8 mV, and a stable cycle performance for 640 cycles at a high current density of 8 mA cm⁻². A full battery using 3D Na@rGO/CNT microlattice as anode was assembled and delivered a capacity of 67.6 mAh g⁻¹ at 100 mA g⁻¹ after 100 cycles.

Yu et al. [ACS Appl. Energy Mater. 2019, 2, 5, 3869-3877] discloses a superelastic graphene lattice (GL) with hierarchical structures was fabricated via a 3D printing technique on the basis of the direct inkjet writing strategy. Due to the pore-structure design of the GL, the rim regions of the holes demonstrated a highly concentrated current density and could serve as preferred sites for Na deposition. This phenomenon was utilized to regulate the Na deposition; hence, a stable Na metal anode is produced. As a result, a high Coulombic efficiency of 99.84% was realized for a long lifetime of 500 cycles (˜1000 h) at a current density of 1 mA cm⁻². These results provide a novel insight into the rational design of graphene-based material structures at multiscale for high-performance Na metal anodes.

Yoon et al. [ACS Appl. Energy Mater. 2018, 1, 5, 1846-1852] discloses sodium metal is a good candidate as an anode for a large-scale energy storage device because of the abundance of sodium resources and its high theoretical capacity (˜1166 mA h g⁻¹) in a low redox potential (−2.71 V versus the standard hydrogen electrode). Yoon et al. report effects of sulfur doping on highly efficient macroporous catalytic carbon nanotemplates (MC-CNTs) for a metal anode. MC-CNTs resulted in reversible and stable sodium metal deposition/stripping cycling over ˜200 cycles, with average Coulombic efficiency (CE) of ˜99.7%. After heat treatment with elemental sulfur, the sulfur-doped MC-CNTs (S-MC-CNTs) showed significantly improved cycling performances over 2400 cycles, with average CEs of ˜99.8%. In addition, very small nucleation overpotentials from ˜6 to ˜14 mV were achieved at current densities from 0.5 to 8 mA cm⁻², indicating highly efficient catalytic effects for sodium metal nucleation and high rate performances of S-MC-CNTs.

Sun et al. [Adv. Mater. 2018, 1801334] discloses that sodium (Na) metal is one of the most promising electrode materials for next-generation low-cost rechargeable batteries. A nitrogen and sulfur co-doped carbon nanotube (NSCNT) paper is used as the interlayer to control Na nucleation behavior and suppress the Na dendrite growth. The N- and S-containing functional groups on the carbon nanotubes induce the NSCNTs to be highly “sodiophilic,” which can guide the initial Na nucleation and direct Na to distribute uniformly on the NSCNT paper. As a result, the Na-metal based anode (Na/NSCNT anode) exhibits a dendrite-free morphology during repeated Na plating and striping and excellent cycling stability. It is also demonstrated that the electrochemical performance of sodium-oxygen (Na—O₂) batteries using the Na/NSCNT anodes show significantly improved cycling performances compared with Na—O₂ batteries with bare Na metal anodes.

Ye et al. [Nano Energy, 2018, 48, 369-376] discloses that Na-C composite anode was fabricated by depositing nanoscale metallic sodium in graphitized carbon microspheres which were assembled from graphitized carbon nanosheets. The carbon microspheres function as a mini-nanoreservoir with high-surface-area, conductivity, and mechanical stability, which lower the local current density, ensure a homogeneous Na nucleation and high electrochemical active of Na, and restrict the volume change. As a result, metallic sodium can be reversibly nondendritic stripped/plated with a high Coulombic efficiency of 99.3% up to 4 mA cm⁻² for 4 mA h cm⁻². Building upon this dendrite-free anode, we demonstrate a full cell using O₃-NaNi_{0.5}Mn_{0.2}Ti_{0.3}O₂ cathode to achieve a superior long lifespan of ˜100 cycles at high current density of 0.5 C.

Polymer materials are reliable precursors to ensure uniformity of Na storage performance but these are very less explored precursors to synthesize carbon anode. Bio-mass is low cost, abundant and scalable choice of precursor for disordered carbon synthesis. However, due to discrepancies in the composition of biomass, there can be a huge difference in the electrochemical performance from batch to batch.

Thus, keeping in view the shortcomings faced while developing the Na ion batteries in the prior art, the inventors of the present invention realized that there exists a dire requirement of carbon anode which is cheaper in cost with higher yield, invariable, highly disordered, tuned pore volume to control ICE, large interlayer spacing, and high conductivity or graphitization. Further, there is a need to address recycling of polymer waste as a cheap precursor for anode synthesis; while realizing the high capacity of Na ion battery anode as well high rate performance due to large interlayer d-spacing, presence of amorphous and graphitized domains in single material providing conductivity and defect sites which are required for Na storage, long cyclic stability of anode in half-cell and high capacity, energy density and cyclic stability of anode in full cell.

### OBJECTIVES OF THE INVENTION

The main objective of the present invention is to provide a biphasic Nitrogen doped sodiophilic anode from waste polymer derived carbon (PDC) and/or commercial polyvinyl based polymer roll carbon (PRC) plated with sodium.

Another objective of the present invention is to provide a process for preparing a biphasic Nitrogen doped sodiophilic anode.

Yet another object of the present invention is to provide a sodium ion/metal battery containing biphasic Nitrogen doped sodiophilic anode.

### SUMMARY OF THE INVENTION

In an aspect, the present invention provides a biphasic Nitrogen doped sodiophilic anode comprising: a defect rich Nitrogen doped waste polymer derived carbon (PDC) and/or commercial polyvinyl based polymer roll carbon (PRC) plated with sodium having BET surface area in the range of 40 m²g⁻¹ to 80 m²g⁻¹ and porevolume in the range of 0.041 cm³/g to 0.63 cm³/g.

In another aspect, the present invention discloses a process of preparing a biphasic nitrogen doped sodiophilic anode comprising the steps of:
a) Cleaning a waste plasticized polyvinyl based polymer packaging (P-PVPP) and/or commercial polyvinyl based polymer material to obtain a first processed material;
b) removing an aluminium layer from the first processed material obtained in step (a) to obtain a second processed material;
c) cutting the second processed material obtained in step (b) and/or commercial poly vinyl based polymer into a small piece;
d) pyrolyzing the third processed material obtained in step (c) under a temperature in the range of 600-1000° C. for a period in the range of 4 h to 6 h under inert atmosphere with 5° C. min⁻¹ ramp rate and subsequently cooling by natural convection to obtain a pyrolyzed material;
e) washing the pyrolyzed material obtained in step (d) with distilled water to obtain a washed pyrolyzed material; and
f) drying the washed pyrolyzed material obtained in step (e) to obtain a defect rich N-doped waste polymer derived carbon (PDC) and/or commercial polyvinyl based polymer carbon (PRC).
g) applying the N-doped waste polymer derived carbon (PDC) and/or polyvinyl based polymer derived carbon (PRC) obtained in step (f) onto a conventional anode to obtain the biphasic nitrogen doped sodiophilic anode.

Further, the present disclosure provides a sodium ion/metal battery comprising:
(i) a biphasic Nitrogen doped sodiophilic anode;
(ii) a cathode;
(iii) an electrolyte; and
(iv) a separator.

### BRIEF DESCRIPTION OF THE ACCOMPANYING DRAWINGS

Characteristics and advantages of the subject matter as disclosed in the present disclosure will become clearer from the detailed description of an embodiment thereof, with reference to the attached drawing, given purely by way of an example, in which:

FIG. 1 depict (a) and (b) XRD of PDC600, PDC1000 and PRC1000 (c) Raman spectra of PDC600 (d) Raman spectra of PDC1000 (e) N2 adsorption isotherm and (f) pore size distribution of PDC600, PDC1000 and PRC1000.

FIG. 2 depicts (a) HRTEM of PDC-600 and (b-c) HRTEM of PDC-1000, (d) SAED pattern, (e-f) crystalfringes of PDC1000

FIG. 3 depicts (a) Survey spectrum (b) C1s spectrum (c) N1s spectrum and (d) C12p spectrum of PDC-600 and PDC1000.

FIG. 4 depict (a) CV of PDC-600 (b) CV of PDC-1000 at 0.1 mVs⁻¹ (c) dQ/dV plot obtained from GCDdata (d) GCD curve of PDC-600 (e) GCD curve of PDC-1000 at 25 mAg⁻¹ (f) Impedance curves (g) rate performance of PDC600, PDC1000 and PRC1000 (h) stability at 2Ag⁻¹ (i) stability at 5Ag⁻¹ and (j) stability at 1Ag⁻¹ of PDC600 and PDC1000.

FIG. 5 depict (a) CV at 0.1 mVs⁻¹ and (c) CD at 0.1 C of PDC1000∥NVPF-0 (b) and (d) CV at 0.1 mVs⁻¹ of PDC1000∥NVPF-1 h at 0.1 C (e) Stability of PDC1000∥NVPF-1 h and PRC1000∥NVPF-1 h.

FIG. 6 depicts (a) Rate performance comparison of PDC1000∥NVPF-0 and PDC1000∥NVPF-1 h (b) Stability of PDC600∥NVPF-1 h.

FIG. 7 depicts (a) Voltage vs. time comparison (b) C.E. comparison of PDC1000 at 2 mAcm⁻²_2 mAhcm⁻² and 4 mAcm⁻²_2 mAhcm⁻², (c) Voltage vs. time plot of PDC1000 at 6 mAcm⁻²_2 mAhcm⁻², (d) Voltage vs. time plot of PDC1000 at 6 mAcm⁻²_4 mAhcm⁻² and (e) C.E. comparison of PDC1000 at 6 mAcm⁻²_2 mAhcm⁻² and 6 mAcm⁻²_4 mAhcm⁻².

FIG. 8 (a) Comparative voltage vs. time plot of PDC600 and PDC1000 at 4 mAcm⁻²_2 mAhcm⁻² and (b) Comparative voltage vs. time plot of PDC600, PDC1000 and PRC 1000 at 6 mAcm⁻²_4 mAhcm⁻², (c) Rate performance and (d) C.E. plot of PDC1000, and (e) stability of Na@PDC1000∥NVPF full cell at 0.1 C.

### DETAILED DESCRIPTION OF THE INVENTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Unless the context requires otherwise, throughout the specification which follow, the word “comprise” and variations thereof, such as, “comprises” and “comprising” are to be construed in an open, inclusive sense that is as “including, but not limited to”.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and appended claims, the singular forms “a,” “an,” and “the” include plural referents unless the content clearly dictates otherwise. It should also be noted that the term “or” is generally employed in its sense including “and/or” unless the content clearly dictates otherwise.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The disclosure described in detail in connection with certain preferred and optional embodiments, so that various aspects thereof may be more fully understood and appreciated.

In an embodiment, the present invention discloses a biphasic Nitrogen doped sodiophilic anode comprising:
a) a defect rich Nitrogen doped waste polymer derived carbon (PDC) and/or
b) commercial polyvinyl based polymer roll carbon (PRC) plated with sodium, having BET surface area in the range of 40 m²g⁻¹ to 80 m²g⁻¹ and pore volume in the range of 0.041 cm³/g to 0.63 cm³/g for PDC as sodiophilic host, with high capacity and long cyclic stability, for sodium ion/metal battery.

The polymer is selected from plasticized poly vinyl based polymer packaging material (P-PVPP) of medical packaging or commercial polymer composed of poly vinyl polymer, plasticizer and stabilizer. The plasticizers are added to provide flexibility and stabilizers are added to provide stability against heat, light, alkali acid and moisture. In another embodiment, the biphasic nitrogen doped sodiophilic anode is prepared by the process comprising the steps of:
a) cleaning a waste plasticized poly vinyl based polymer packaging (P-PVPP) material to obtain a first processed material;
b) removing an aluminium layer from the first processed material obtained in step (a) to obtain a second processed material;
c) cutting the second processed material obtained in step (b) and/or commercial poly vinyl based polymer into a small piece;
d) pyrolyzing the small pieces obtained in step (c) under a temperature in the range of 600-1000° C. for a period in the range of 4 h to 6 h under inert atmosphere with 5° C. min⁻¹ ramp rate and subsequently cooling by natural convection to obtain a pyrolyzed material;
e) washing the pyrolyzed material obtained in step (d) with distilled water to obtain washed pyrolyzed material; and
f) drying the washed pyrolyzed material obtained in step (e) at a temperature in the range of 70-90° C. overnight for 8-12 h in an oven to obtain the defect rich N-doped waste polymer derived carbon (PDC) and/or polyvinyl based polymer derived carbon (PRC); and
g) applying the N-doped waste polymer derived carbon (PDC) and/or polyvinyl based polymer derived carbon (PRC) obtained in step (f) onto a conventional anode to obtain the biphasic nitrogen doped sodiophilic anode.

In preferred embodiment, the cleaning in step a) includes cleaning of the waste P-PVPP material with deionized water and drying at a temperature in the range of 70-100° C.

In another preferred embodiment, the conditions in step d) include a temperature in the range of 600-1000° C. for a period of in the range of 3 to 6 h under inert argon atmosphere with 5° C. min⁻¹ ramp rate and subsequently cooled by natural convection.

In yet another preferred embodiment, the drying of step f) was carried out at a temperature in the range of 70-90° C. overnight around 8-12 h in an oven.

The commercial poly vinyl chloride (PVC) polymer undergoes carbonization at the temperature ranging between 600-1000° C. in two steps which include (i) dehydrochlorination (DHC) and formation of conjugated unsaturated double bonds; and (ii) the formation of the aromatic compound due to the cyclization of polyenes.

The natural convection is a mechanism of heat transportation in which the fluid motion is not generated by an external source. Instead the fluid motion is caused by buoyancy, the difference in fluid density occurring due to temperature gradients.

In another aspect, the present invention provides defect rich N-doped polymer derived carbon (PDC) and/or commercial polymer derived carbon (PRC) plated with sodium as anode material for sodium-ion half cell battery and sodium metal full cell battery.

The polymer derived carbon may in the form of carbon nanotube (CNT), carbon spheres and carbon sheets. In the present invention, carbon has sheet like morphology.

In an embodiment, the present invention discloses defect rich, biphasic nitrogen doped polymer derived carbon (PDC) viz. PDC600 and PDC1000 (from waste polymer), and PRC1000 (from commercial plasticized polyvinyl based polymer). The values 600 and 1000 in PDC600 and PDC1000 represent the pyrolysis temperatures.

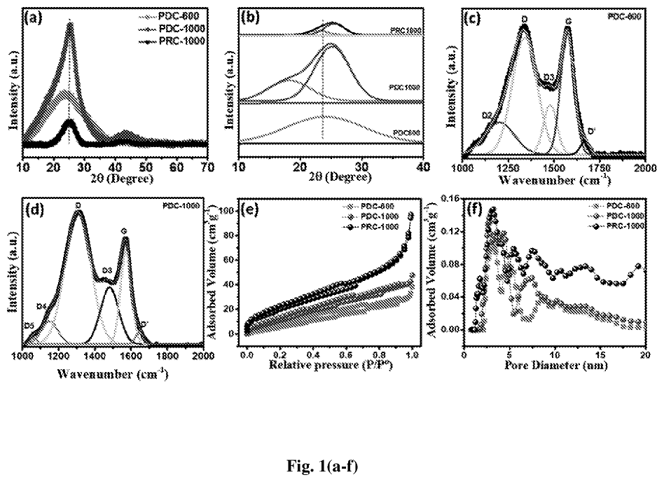

The PDC600, PDC1000 and PRC1000 are characterized by XRD as shown in FIGS. 1(a) and 1 (b). XRD of PDC600, PDC1000 and PRC1000 include peaks positioned around 24.24°, 25.16°, and 25.5 respectively representing incomplete graphitization of carbon expected in material obtained from pyrolysis at relatively low temperature than graphite synthesis temperature (2600° C.). These peaks are shifted to lower theta values from the graphitic peak (26°) which corresponds to (002) plane of graphite. This shift is an indication of the formation of turbostratic carbon which is formed due to incomplete graphitization (less ordering) of carbon. The peak corresponding to (002) plane of PDC1000 is sharp and narrow in comparison to PDC600 which signifies an increased extent of graphitization/ordering and decreased interlayer spacing at the higher temperature. The Interlayer d-spacing values calculated using Bragg's law for PDC600 and PDC1000 showed the d-spacing value of 0.37 (2θ=23.77) for PDC600. The PDC1000 showed two peaks with peak at 2θ=18° corresponding to d=0.49 nm which represents highly disordered domains and peak at 2θ=25.16° corresponding to d=0.35 nm representing graphitic nanodomains. The PRC1000 showed two peaks with peak at 2θ=22.77° corresponding to d=0.39 nm and peak at 2θ=25.5° corresponding to d=0.35 nm. The Large d-spacing in PDC1000 was observed to contribute to a high rate of Na⁺ ion storage without a barrier. Increased graphitization imparted more conductivity and better rate performance in the battery.

Further, the PDC600 and PDC1000 were characterized using Raman spectroscopy. Raman spectra of PDC600 and PDC1000 are shown in FIG. 1 (c) and (d), respectively. The intensity ratio between D and G bands (I_{D}/I_{G}) is proportional to degree of disorder in the carbon materials. I_{D}/I_{G} values (intensity wise) obtained after deconvolution are 0.95 and 1.41 in PDC600 and PDC1000, respectively which indicates a higher degree of disorder and defects than graphitization in the PDC1000 in comparison to PDC600.

An important feature that rules the electrochemical performance of anode material is the accessibility of electrolyte molecules to the core of electrode material and it can be explained by the surface area and pore size distribution. As shown in FIGS. 1(e) and 1(f), the BET surface area and pore volume of PDC600 are 43 m² g⁻¹, and 0.043 cm³/g respectively, whereas, the BET surface area and pore volume of PDC1000 are 57 m²g⁻¹ and 0.062 cm³/g, respectively.

Also, the BET surface area and pore volume of PRC1000 are 74 m²g⁻¹ and 0.113 cm³/g, respectively. An increase in surface area of PDC1000 is due to the release of small molecules during carbonization and dehydrochlorination which results in the formation of interconnected pores and defects. With increase in temperature the mesoporous density in PDC1000 was observed to increase. Mesopores closed between the misaligned layers of carbons lead to pseudo-adsorption or clustering of Na⁺ ions indicating PDC1000 as more effective sodium storage material.

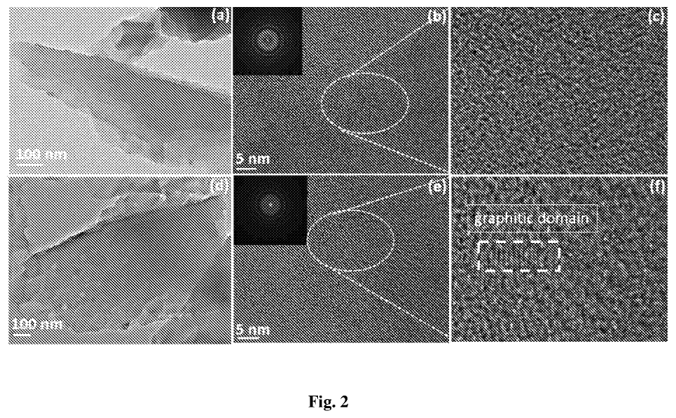

The HRTEM image of PDC 600 (FIG. 2 (a-c) and PDC1000 (FIG. 2 (d-f) indicate the presence of crumpled sheet like morphology in PDC. By comparing FIG. 2 (a) and (d), it was observed that PDC1000 shows porosity in the carbon sheets which could be assigned to extraction of molecules from the carbon backbone at higher carbonization temperature. Presence of diffuse rings in SAED pattern of PDC signifies amorphous nature of carbon (inset of FIG. 2 (b and e)) which is in agreement with XRD data and Raman data discussed above.

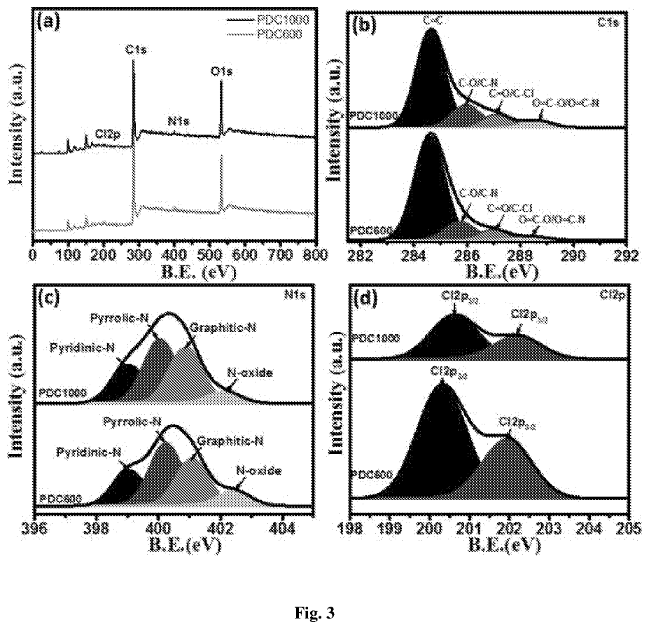

Further, the nature of surface of carbon materials, presence of functional and dopant groups was studied using X-ray photoelectron spectroscopy (XPS) measurements. The survey spectrum, C1s, N1s, and Cl2p spectra are presented in FIG. 3 (a-d). The PDC shows existence of C, O, N and Cl. C1s spectrum is shown in FIG. 3 (b) which indicates presence of C═C, C—O/C—N, C═O/C—Cl and O═C—O/OC—N bonds at binding energy (B.E) values of 284.6, 285.9, 287.1 and 288.6 eV, respectively. The doped N-atom into carbon structure of the present invention was categorized into three types viz. pyridinic (N-6), pyrrolic (N-5) and graphitic (N-Q). The Pyridinic (N-6) and Pyrrolic (N-5)N-atoms are located at edges or defect sites whereas graphitic N-atom substitute carbon in hexagonal lattice. The source of N-atoms is the additive to poly vinylpolymer which is added to stabilize the poly vinyl polymer film. In PDC anode, N1s spectra are deconvoluted into 3 peaks and results are shown in FIG. 3 (c). The pyridinic, pyrrolic, graphitic and N-oxide species are present at binding energy values of 398.9, 400, 400.9 and 402.3 eV, respectively. Presence of pyridinic and pyrrolic N-atom is expected to show enhance conductivity and charge storage properties. C12p spectrum is shown in FIG. 3 (d) which can be deconvoluted into two peaks Cl 2p1/2 and Cl 2p3/2 at B.E values of 200.6 and 202.2 eV, respectively. The relative intensity of Cl2p peaks in PDC1000 is decreased than PDC600 which is in agreement with dechlorination of poly vinyl chloride at higher temperatures.

In another embodiment, the present invention discloses the Na∥PDC600 half cell, wherein, in the cyclicvoltammetry (CV) study during first cathodic scanning cycle, peaks at 0.57 V and 0.83 are observed which could be attributed to irreversible SEI formation on the surface of the anode and Na⁺ ion storage on functional group sites, respectively. Also, a sharp cathodic peak around 0.04 V and anodic peak around 0.07V, are observed in all the cycles which are due to Na⁺ ion storage in interlayer space.

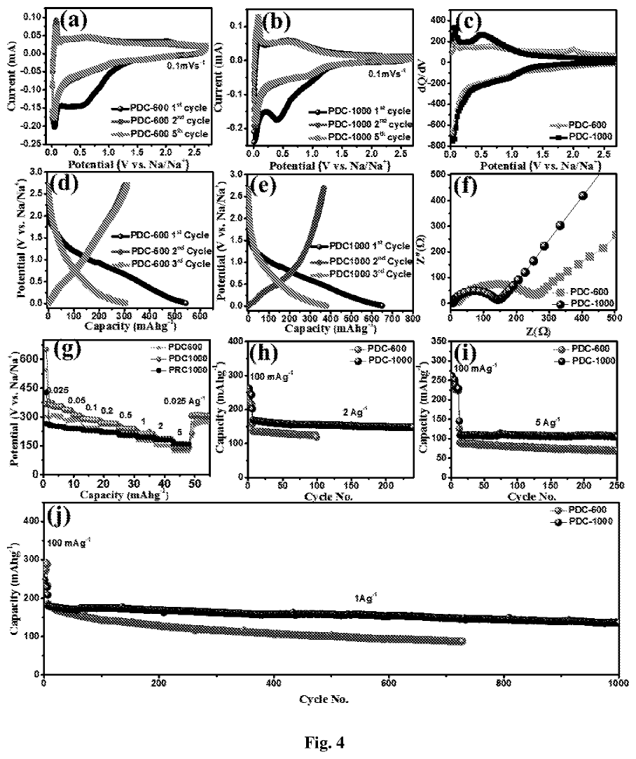

In yet another embodiment, the present invention discloses the Na∥PDC1000, wherein, in the cyclicvoltammetry (CV) study (FIG. 4a-c) during first cathodic scanning cycle peaks at 0.41 V and 0.96 are observed which could be assigned to irreversible SEI formation and Na⁺ ion interaction with surface functional groups (sloping capacity), respectively. Also, sharp cathodic peaks around 0.04V and anodic peak around 0.08 V are observed which signifies the Na⁺ ion intercalation into and de-intercalation from the interlayers of carbon. The galvanostatic charge-discharge cycles between 0.01 to 2.7 V vs. Na/Na⁺ at 25 mAg⁻¹ current density (FIG. 4 (d & e)) shows the first reversible capacity of 302 mAhg⁻¹ and 366 mAhg⁻¹ for Na∥PDC600 and Na∥PDC1000, respectively. EIS data of Na∥PDC600 and Na∥PDC1000 shown in FIG. 4(f) depicts the enhanced charge transfer in carbon synthesized at higher temperature. The increase in the peak current of peak <0.1V and peak in between 0.1V-1V in Na∥PDC1000 in comparison to Na∥PDC600 relate to more Na⁺ ion storage in the nanopores and interlayers of PDC1000 which is in accordance with XRD, Raman, high surface area and pore volume results of PDC1000 anode.

Further, FIG. 4(g-j) shows the rate and cycling performance of the Na∥PDC600, Na∥PDC1000, Na∥PRC1000 respectively. The capacity of 307 mAh g⁻¹ and 354 mAh g⁻¹ was obtained at 25 mA g⁻¹ for Na∥PDC600 and Na∥PDC1000, respectively. When the current density was increased to 50, 100, 200, 500, 1000, 2000 and 5000 mAg⁻¹, the capacity obtained for Na∥PDC1000 is 306 mAh g⁻¹, 283 mAh g⁻¹, 265 mAh g⁻¹, 237 mAh g⁻¹, 211 mAh g⁻¹, 184 mAh g⁻¹, and 141 mAh g⁻¹ respectively. In contrast, for PDC600 capacity is 284 mAh g⁻¹,243 mAh g⁻¹, 223 mAh g⁻¹, 197 mAh g⁻¹, 174 mAh g⁻¹, 150 mAh g⁻¹, and 119 mAh g⁻¹ respectively. Whereas PRC1000 shows capacity of 238 mAh g⁻¹, 228 mAh g⁻¹, 220 mAh g⁻¹, 205 mAh g⁻¹, 193 mAh g⁻¹, 179 mAh g⁻¹, and 158 mAh g⁻¹, respectively. This clearly demonstrates the high rate capability and good capacity retention characteristics of PDC1000 material for Na ion Battery application.

The long cyclic stability studies were performed at higher current and PDC1000 anode revealed capacity of 173 mAh g⁻¹, 154 mAh g⁻¹ and 108 mAh g⁻¹ at 1, 2 and 5 Ag⁻¹ current densities, whereas, PDC600 displayed capacity of 143 mAh g⁻¹, 118 mAh g⁻¹ and 78 mAh g⁻¹ at 1, 2 and 5 Ag⁻¹ current densities respectively.

The large interlayer d-spacing, more defect sites, high surface area, more pore volume in mesoporous region and better crystallinity were observed to be responsible for excellent electrochemical performance of PDC1000 in sodium ion battery (NIB) half-cell.

In yet another embodiment, the present invention discloses NVPF half cell.

The present disclosure discloses a sodium ion/metal battery comprising: a biphasic Nitrogen doped sodiophilic anode; a cathode; an electrolyte; and a separator.

The cathode is selected from a group consisting of Na₃V₂(PO₄)₂F₃ (NVPF), prussian blue analogue Na₂Fe[Fe(CN)₆] and prussian white analogue Na_{1.88}Fe[Fe(CN)₆]×0.7H₂O and preferably the cathode is Na₃V₂(PO₄)₂F₃ (NVPF).

The electrolyte is selected from a group consisting of 1M NaPF₆ in ethylene carbonate (EC)/diethylene carbonate (DEC) with the additives such as NaF and SnF₂.

The anode is hard carbon (PDC or PRC) non-sodiated or pre-sodiated by coating or spraying of the solution containing Na-metal and coating of Na-complexes such as Na-biphenyl and Na-naphthalene onto the anode surface to compensate sodium in solid electrolyte interphase (SEI).

The cathode is non-sodiated or pre-sodiated by coating or spraying of the solution of sodium citrate, sodium mesoxalate (SMO) and Na₂S onto the cathode surface to compensate sodium in solid electrolyte interphase (SEI).

The sodiophilic material which is defect rich and/or N-doped carbon used as anode in the half cell and the battery (full cell) in the present invention is obtained by recycling of waste polymer packaging which solves the energy and environmental issues in a sustainable and energy efficient manner. Also, sodiophilic carbon is obtained from commercial poly vinyl based polymer.

In another embodiment, the present invention relates to sodium ion battery (full cell) with high capacity and long cyclic stability comprising;
(i) the cathode;
(ii) the anode consisting of defect rich N-doped polymer derived carbon (PDC) or PRC;
(iii) the electrolyte; and
(iv) the separator.

The cathode for the battery is selected from Na₃V₂(PO₄)₂F₃ (NVPF), Prussian blue analogues e.g. Na₂Fe[Fe(CN)₆] and Prussian white Na_{1.88}Fe[Fe(CN)₆]×0.7H₂O) and the like; preferably the cathode is Na₃V₂(PO₄)₂F₃ (NVPF).

The electrolyte for the battery is selected from 1M NaPF₆ in ethylene carbonate (EC)/diethylene carbonate (DEC) with the additives such as NaF and SnF₂, and the separator is made of microporous glass fiber and celgard.

In another embodiment, the pre-sodiation of anode surface of N-doped polymer derived carbon (PDC) in half cell is carried out by coating or spraying of the solution containing Na-metal and coating of Na-complexes such as Na-biphenyl and Na-naphthalene onto the anode surface to compensate sodium in solid electrolyte interphase (SEI).

In yet another embodiment, the pre-sodiation of cathode surface of N-doped polymer derived carbon (PDC) and/or PRC in the battery comprises spraying or coating of the solution of sodium citrate, sodium mesoxalate (SMO) and Na₂S onto the cathode surface to compensate sodium in solid electrolyte interphase (SEI).

In an embodiment, the present invention discloses the cathode for sodium ion batteries selected from fluorophosphate-based cathodes such as Na₃V₂(PO₄)₂F₃ (NVPF).

In another preferred embodiment, the present invention discloses sodium metal battery (full cell) comprising;
(i) the cathode consisting of Na₃V₂(PO₄)₂F₃ (NVPF);
(ii) the anode consisting of defect rich N-doped polymer derived carbon (PDC and/or PRC) plated with sodium;
(iii) the electrolyte consisting of 1M NaPF₆ in ethylene carbonate (EC)/diethylene carbonate (DEC) with the additives such as NaF or SnF₂; and
(iv) the separator is of microporous glass fiber and celgard.

The cathode and the anode for the full sodium ion battery may be pre-sodiated.

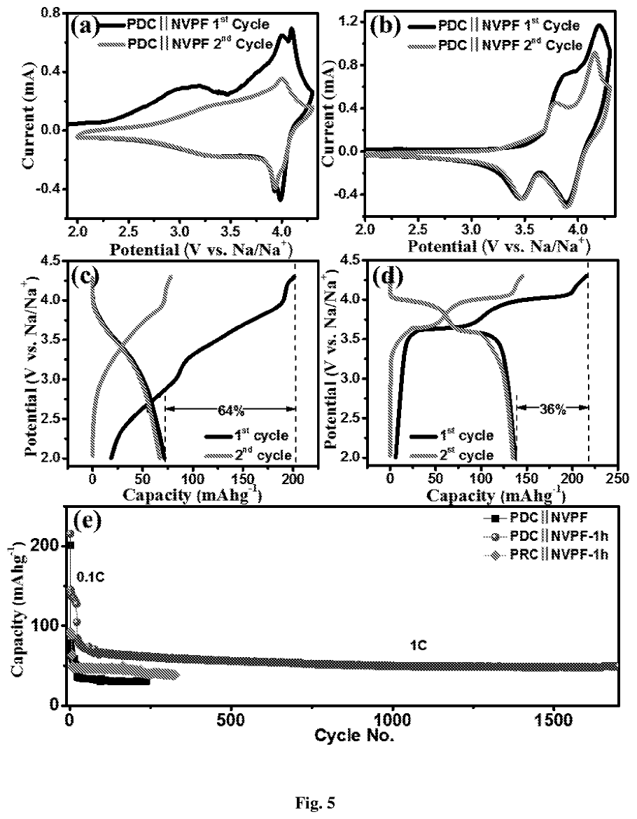

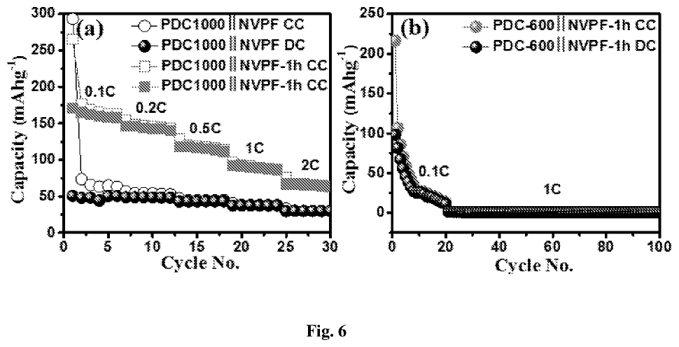

In an embodiment, the CV and GCD of PDC1000∥NVPF cells are presented in FIG. 5 (a-d). The CV curve for pre-sodiated full cell (FIG. 5 (b)) reveals clearly the two Na⁺ extraction peaks and reversibility better in comparison to non pre-sodiated cell (FIG. 6 (a)). From GCD curves of full cell, it is concluded that irreversible capacity loss (ICL) is drastically reduced from 64% to 36% when cell is pre-sodiated (FIG. 5 (c) and (d)). Further, the full cell PDC600∥NVPF shows drastic capacity fading while PDC1000∥NVPF gives 49mAhg⁻¹ capacity at 1 C after 1000 cycles and the corresponding energy density of 171 Whkg⁻¹ at 1 C (FIG. 5(a-c)) and FIG. 6. PRC1000∥NVPF full cell gives capacity of 39mAhg⁻¹ capacity at 1 C after 300 cycles.

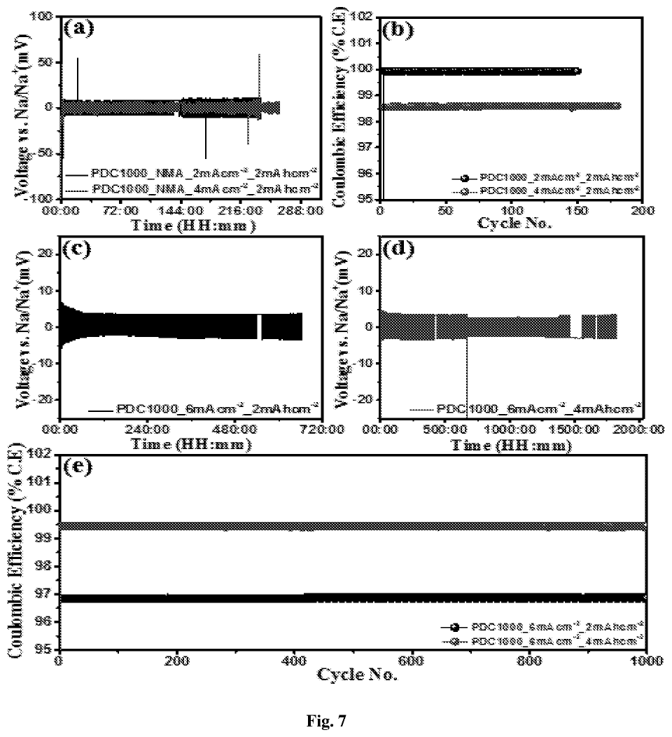

In an embodiment, defect rich N-doped polymer derived carbon (PDC and/or PRC) as anode material of the present invention when applied as NIB anode in half-cell and full cell with NVPF as cathode showed the highest electrochemical capacity of 173 mAhg⁻¹ at 1Ag⁻¹ and 50 mAhg⁻¹ at 1 C, respectively. As NMA host, a high coulombic efficiency (C.E) of 99.45% for over 1000 cycles at 6 mAcm⁻² and 4 mAhcm⁻² is obtained (FIGS. 7&8).

In an embodiment, the present invention disclose the mesoporous carbon obtained from waste plasticized polyvinyl polymer precursor (P-PVPP) and/or commercial plasticized polyvinyl for storage of sodiumions to be used as anode material for sodium-ion and sodium metal battery.

### EXAMPLES

The present disclosure is further explained in the form of following examples. However, it is to be understood that the foregoing examples are merely illustrative and are not to be taken as limitations upon the scope of the invention. Various changes and modifications to the disclosed embodiments will be apparent to those skilled in the art. Such changes and modifications may be made without departing from the scope of the invention.

### Example 1: Synthesis of Battery Grade Carbon (i.e. Carbonized PDC600 and PDC1000 and PRC1000)

Plasticized poly vinyl polymer packaging was (P-PVPP) obtained from a medical store located in Pune, Maharashtra, India, and commercial poly vinyl polymer roll was obtained from supplier. P-PVPP was cleaned with de-ionized water and dried. Further, Al layer was removed from the waste polymer packaging and the polymer layer was cut into small pieces. The P-PVPP was pyrolyzed at 600 and 1000° C. for 4 h in Argon gas atmosphere with 5° C. min 1 ramp rate and then allowed to cool down by natural convection. Further, the pyrolyzed sample was washed with distilled water. Finally, samples were dried at 80° C. overnight in the oven. The dried product was labeled as carbonized polymer derived carbon (PDC) viz. PDC600 and PDC1000 from waste plasticized polyvinyl polymer and PRC from commercial polyvinyl polymer roll.

### Example 2: Synthesis of Na₃V₂(PO₄)₂F₃ (NVPF)/CNT

Na₃V₂(PO₄)₂F₃ (NVPF)/CNT was synthesized using the hydrothermal method. 5-8 wt % of CNT, oxalic acid, ammonium metavanadate, and NaF were added to D.I water and stirred for 30 minutes. Solution was transferred to 45 ml Teflon lined autoclave and kept at 180° C. for 12 h. Reaction product was washed several times and dried to get powder NVPF.

### Example 3: Characterization of Carbonized Polymer Derived Carbon (PDC) Viz PDC600 and PDC1000 and PRC1000

The synthesized products were characterized by various techniques such as powder X-ray diffraction measurements using a Philips X'Pert PRO diffractometer with nickel-filtered Cu Kα radiation, Raman spectroscopy using a LabRam HR800 from JY Horiba, Hitachi S-4200 field emission scanning electron microscope (FESEM), transmission electron microscopy (TEM, FEI Tecnai F20 FEG with 200 KV), High-resolution transmission electron microscopy (HR-TEM) using JEOL 2100F microscope and binding energy studies using X-ray photoelectron spectroscopy (XPS) (Thermo Scientific) with Al-Kα (1486.7 eV) radiation source at room temperature under ultra-high vacuum (10-8 Pa). XPS data was Carbon corrected with the standard C1s peak (284.8 eV). The gas adsorption experiment (up to 1 bar) was performed on a Quantochrome Autosorb automated gas sorption analyzer. TGA was performed using Perkin Elmer TGA7 in an air atmosphere.

### (i) XRD Study

The XRD pattern of PDC600 and PDC1000 is shown in FIG. 1 (a) and (b). XRD of PDC600, PDC1000 and PRC1000 include peaks positioned around 24.24°, 25.16° and 25.50, respectively representing incomplete graphitization of carbon expected in material obtained from pyrolysis at relatively low temperature than graphite synthesis temperature (2600° C.). These peaks are shifted to lower theta values from the graphitic peak (26°) which corresponds to (002) plane of graphite. This shift is an indication of the formation of turbostratic carbon which is formed due to incomplete graphitization (less ordering) of carbon. Structure with d-spacing >0.4 nm represents highly disordered carbon, d-spacing of 0.37 nm-0.4 nm indicates the graphitic structure and d-spacing <0.36 nm corresponds to the quasi-graphitic structure. Slit pores or disordered structures ≥0.37 nm can store Na⁺ ions without an energy barrier so the presence of pores of this size range is necessary for Na⁺ ion storage in carbon structure. The peak corresponding to (002) plane of PDC1000 is sharp and narrow in comparison to PDC600 which signifies an increased extent of graphitization/ordering and decreased interlayer spacing at the higher temperature. The Interlayer d-spacing values of both carbon anodes were calculated using Bragg's law. The d-spacing value is found to be 0.37 (2θ=23.77) for PDC600. Due to the asymmetric nature of the peak corresponding to (002) plane of PDC1000, it was de-convoluted into two peaks using the pore-fitting method representing different carbon structures which resulted into biphasic nature of carbon. Peak at 2θ=18° corresponds to d=0.49 nm which represents highly disordered domains and peak at 2θ=25.16° corresponds to d=0.35 nm which represents graphitic nano domains. The PRC1000 showed two peaks with peak at 2θ=22.77° corresponding to d=0.39 nm and peak at 2θ=25.5° corresponding to d=0.35 nm. Crystalline growth of the graphitic domain is restricted due to the presence of misaligned and amorphous carbon in between. There is a co-existence of graphitic and amorphous nano domains which can provide conductivity as well as Na⁺ storage sites in a single material. Large d-spacing in PDC1000 could contribute to a high rate of Na⁺ ion storage without a barrier. Increased graphitization imparts more conductivity and better rate performance in the battery.

### (ii) Raman Spectroscopy

Raman spectra of PDC600 and PDC1000 are shown in FIG. 1 (c) and (d), respectively. In a complete graphitic sample, G band is observed at 1586 cm⁻¹ which represents C—C bond stretching of sp² bonded carbon. In non-graphitized materials, D band is observed at 1350 cm⁻¹ which represents in plane breakage of infinite graphitic order in the carbon lattice. The position, intensity (relative to G band) and broadening of D band depend upon the nature and type of disorders, the functional groups, dopants and porosity present in the system. The intensity ratio between D and G bands (I_{D}/I_{G}) is proportional to degree of disorder in the carbon materials. I_{D}/I_{G} values (intensity wise) obtained after deconvolution are 0.95 and 1.41 in PDC600 and PDC1000, respectively which indicates a higher degree of disorder and defects than graphitization in the PDC1000 in comparison to PDC600. It is reported that surface defects play important role in Na⁺ ion storage so PDC1000 is expected to be suitable anode material for sodium ion battery (NIB). D1, D2, D3 and D′ defects are also present in the carbon anodes due to functional group or doping defects. D3 peak indicates presence of amorphous carbon due to organic molecules. D′ peak represents surface graphitic lattices or edges. D4 peak corresponds to mixed sp²-sp³ bonds at the surface or peripheral polyenes. Microstructural features of local layers such as open or closed pores or the presence of dopants such as O and N forbid the rotation and gliding of carbon layers which results into incomplete graphitization. As these defects act as Na⁺ storage sites, the presence of more defects channel more Na⁺ storage in the anode. The d-spacing and I_{D}/I_{G} ratio comparison of PDC600 and PDC1000 is shown in table 1.

TABLE 1
d-spacing and I_{D}/I_{G} comparison of PDC600 and PDC1000

| | Highly Disordered | | | Pseudographitic | | | |
|---|---|---|---|---|---|---|---|
| | 2θ[°] | d₀₀₂[nm] | Area[%] | 2θ[°] | d₀₀₂[nm] | Area[%] | I_{D}/I_{G} |
| PDC600 | — | | | 24.24 | 0.37 | 100 | 0.95 |
| PDC1000 | 18 | 0.49 | 31 | 25.16 | 0.35 | 69 | 1.41 |
| PRC1000 | 22.77 | 0.39 | 27 | 25.50 | 0.35 | 73 | |

(iii) BET Surface Area and the Pore Size Distribution.

Another important factor that rules the electrochemical performance of anode materials is the accessibility of electrolyte molecules to the core of electrode material which can be explained by the surface area and pore size distribution. BET measurement was performed to study the surface area and the pore size distribution, and results are shown in FIG. 1 (e and f). The BET surface area and pore volume of PDC600 are 43 m²g⁻¹ and 0.043 cm³/g respectively. The BET surface area and pore volume of PDC1000 are 57 m²g⁻¹ and 0.062 cm³/g respectively. Also, the BET surface area and pore volume of PRC1000 are 74 m²g⁻¹ and 0.113 cm³/g, respectively. An increase in surface area of PDC1000 is due to the release of small molecules during carbonization and dehydrochlorination which results in the formation of interconnected pores and defects. Pore size distribution data also observe a similar trend. As temperature increases, mesoporous density increases in PDC1000. Mesopores closed between the misaligned layers of carbons lead to pseudo-adsorption or clustering of Na⁺ ions. More surface area, mesoporisty, more pore volume and large defects density indicate that PDC1000 can provide more Na storage material in comparison to PDC600.

### (iv) HRTEM Study

The HRTEM image in FIG. 2 characterizes the presence of crumpled sheet like morphology in PDC. By comparing FIG. 2 (a) and (d), we observed that PDC1000 shows porosity in the carbon sheets which can be assigned to extraction of molecules from the carbon backbone at higher carbonization temperature. Presence of diffuse rings in SAED pattern of PDC signifies amorphous nature of carbon (inset of FIG. 2 (b and e)) and it is in agreement with XRD data and Raman data discussed in earlier. In PDC 600 graphitic ordering is not observed which indicates that higher temperature is required for graphitization. Further, crystal fringe analysis was executed and co-existence of pseudographitic and amorphous domains in the PDC1000 sample corroborate with XRD result and confirms formation of biphasic microstructure. The pseudographitic domains provide conductivity and amorphous nature provide large interlayer d-spacing which both are indispensable for substantial Na storage.

### (v) X-Ray Photoelectron Spectroscopy (XPS) Measurements

The survey spectrum of C1s, N1s, and C12p spectra is provided in FIG. 3 (a). The existence of surface functional groups is reported to act as active sites for Na⁺ storage. Doped N-atom into carbon structure can be categorized into 3 types which are pyridinic (N-6), pyrrolic (N-5) and graphitic (N-Q). The Pyridinic (N-6) and Pyrrolic (N-5)N-atoms are located at edges or defect sites whereas graphitic N-atom substitute C in hexagonal lattice. According to DFT, it is predicted that N-atoms at edges or defect sites are energetically more favorable for Na⁺ ion storage, heterogeneous nucleation and guided Na plating through acid-base interactions than graphitic N-atoms. It is because N atoms act as Lewis base for nucleation of Na so the presence of N-atom doping will not only increase the conductivity but also act as pseudocapacitance Na⁺ storage site. In the present invention, the source of N-atoms is the additive to poly vinyl based polymer which is added to stabilize the—poly vinyl based polymer film. In PDC anode, N1s spectra are deconvoluted into 3 peaks and results are shown in FIG. 3 (c). The pyridinic, pyrrolic, graphitic and N-oxide species are present at binding energy values of 398.9, 400, 400.9 and 402.3 eV, respectively. Presence of pyridinic and pyrrolic N-atoms are anticipated to show enhance conductivity and charge storage properties as discussed previously. C12p spectrum is shown in FIG. 3 (d) which can be deconvoluted into two peaks Cl 2p1/2 and Cl 2p3/2 at B.E values of 200.6 and 202.2 eV, respectively. The relative intensity of Cl2p peaks in PDC1000 is decreased than PDC600 which is in agreement with dechlorination of PVC/PVDC at higher temperatures. The PDC shows existence of C, O, N and Cl. The C1s spectrum is shown in FIG. 3 (b) which indicates presence of C═C, C—O/C—N, C═O/C—Cl and O═C—O/O═C—N bonds at binding energy (B.E) values of 284.6, 285.9, 287.1 and 288.6 eV, respectively.

### (vi) Electrochemical Measurements

A coin-type test cell (CR2032) was utilized to evaluate the electrochemical performance of PDC electrodes. The working electrode was prepared by using a slurry consisting of 70 wt. % active material, 20 wt. % conductive carbon and 10 wt. % PVDF using NMP as a solvent. Sodium metal is used as a counter electrode and a microporous glass fiber (Whatman, Cat. No. 1825047, UK) was used as the separator. The electrolyte used for Sodium cells is 1 M NaPF₆ in diglyme electrolyte. For full cell, 1 M NaPF₆ in a mixture (1:1, in vol %) of ethylene carbonate (EC) and diethyl carbonate (DEC) with 5% FEC is used. The cells were assembled in an argon-filled glove box (02 level <0.1 ppm and H₂O <0.1 ppm). For full cell studies, anode and cathode were pre-sodiated (PS) for 1 hour and 15 minutes, respectively, before assembling cells. For NMA cells, we first discharged cells to 0.01 V at 25 mAg⁻¹ to form SEI before doing plating/stripping experiments. The cyclic voltammetry (CV) and electrochemical impedance spectroscopy (EIS) were performed on a Biologic workstation at the scan rate of 0.1 mV/s. Galvanostatic charge-discharge (GCD) measurements were performed using MTI Corp. multi-channel battery test system.

### Example 4: Na-Ion Battery Electrochemical Data

The electrochemical performance of PDC anode was tested in 2032 coin cells in half-cell and full-cell assembly. Initially, to understand the Na ion interaction with the as prepared materials, CV curves were recorded and results are shown in FIG. 4. In the CV of Na∥PDC600, during first cathodic scanning cycle, peaks at 0.57 V and 0.83 are observed which can be assigned to irreversible SEI formation on the surface of the anode and Na⁺ ion storage on functional group sites, respectively. Also, a sharp cathodic peak around 0.04 V and anodic peak around 0.07 V, are observed in all the cycles which are due to Na⁺ ion storage in interlayer space. In the CV of Na∥PDC1000, during first cathodic scanning cycle peaks at 0.41 V and 0.96 are observed which can be assigned to irreversible SEI formation and Na⁺ ion interaction with surface functional groups (sloping capacity), respectively. Also, sharp cathodic peaks around 0.04 V and anodic peak around 0.08V are observed which signifies the Na⁺ ion intercalation into and de-intercalation from the interlayers of carbon. Increase in the peak current of peak <0.1V and peak in between 0.1V-1V in Na∥PDC1000 in comparison to Na∥PDC600 speak for more Na⁺ ion storage in the nanopores and interlayers of PDC1000. This finding is in accordance with XRD, Raman, high surface area and pore volume results of PDC1000 anode.

The comparative DC plot for Na∥PDC600 and Na∥PDC1000 is shown in FIG. 4 (c) wherein an increased area under the curve is observed in case of Na∥PDC1000 than Na∥PDC600. Intercalation and pseudocapacitance capacity is more in PDC1000. Further, the electrochemical performance as NIB anode is evaluated using galvanostatic charge-discharge cycles between 0.01 to 2.7 V vs. Na/Na⁺ at 25 mAg⁻¹ current density (FIG. 4 (d)). The first reversible capacity is 302 mAh g⁻¹ and 366 mAh g⁻¹ for Na∥PDC600 and Na∥PDC1000, respectively. EIS data of Na∥PDC600 and Na∥PDC1000 is shown in FIG. 4 (f) which shows enhanced charge transfer in carbon synthesized at higher temperature.

Rate and cycling performance of the Na∥PDC600, Na∥PDC1000 and Na∥PRC1000 are shown in FIG. 4 (g-i) to study capacity behavior with increasing current density. The capacity of 307 mAhg⁻¹ and 354mAhg⁻¹ was obtained at 25mAg⁻¹ for Na∥PDC600 and Na∥PDC1000, respectively. When the current density was increased to 50, 100, 200, 500, 1000, 2000 and 5000 mAg⁻¹, the capacity obtained for Na∥PDC1000 is 306 mAh g⁻¹, 283 mAh g⁻¹, 265 mAhg⁻¹, 237 mAhg⁻¹, 211mAhg⁻¹, 184mAhg⁻¹, and 141 mAh g⁻¹ respectively. Whereas PRC1000 shows capacity of 238 mAh g⁻¹, 228 mAh g⁻¹, 220 mAh g⁻¹, 205 mAh g⁻¹, 193 mAh g⁻¹, 179 mAh g⁻¹, and 158 mAh g⁻¹, respectively. In contrast, for PDC600 capacity is 284 mAh g⁻¹, 243 mAhg⁻¹, 223 mAh g⁻¹, 197 mAh g⁻¹, 174mAhg⁻¹, 150mAg⁻¹, and 119 mAh g⁻¹ respectively. This clearly demonstrates the high rate capability and good capacity retention characteristics of PDC1000 material for Na ion Battery application. The reason for excellent rate performance at higher current is large interlayer d-spacing and controlled pore size distribution in PDC1000 anode. The long cyclic stability studies were performed at higher current and PDC1000 anode revealed capacity of 173mAhg⁻¹, 154mAhg⁻¹ and 108mAhg⁻¹ at 1, 2 and 5 Ag⁻¹ current densities, whereas, PDC600 displayed capacity of 143 mAh g⁻¹, 118 mAh g⁻¹ and 78 mAh g⁻¹ at 1, 2 and 5 Ag⁻¹ current densities. Large interlayer d-spacing, more defect sites, high surface area, more pore volume in mesoporous region and better crystallinity are responsible for excellent electrochemical performance of PDC1000 in NIB half-cell.

### Example 5: Electrochemical Performance of PDC1000 Fabricated with NPVF Cathode (PDC1000∥NVPF) in Full Cells

The cyclovoltammetry (CV) and galvanostatic (GCD) study of PDC1000∥NVPF cells are presented in FIG. 5. The NVPF cathode exhibits two Na⁺ ion extraction peaks, first Na⁺ extraction at 3.7V and second Na⁺ extraction at 4.2 V. From the CV curves, it can be observed that pre-sodiated full cell (FIG. 5 (b) reveals clear two Na⁺ extraction peaks and reversibility is better in comparison to without pre-sodiated cell (FIG. 5 (a). From GCD curves of full cell, it can be concluded that irreversible capacity loss (ICL) is drastically reduced from 64% to 36% when cell is pre-sodiated (FIG. 5 (c) and (d)).

The rate performance and stability data of full cells are shown in FIG. 6. The full cell PDC600∥NVPF shows drastic capacity fading while PDC1000∥NVPF gives 49 mAh g⁻¹ capacity at 1 C after 1000 cycles and the corresponding energy density is 171 Whkg⁻¹ at 1 C. PRC1000∥NVPF full cell gives capacity of 39mAhg⁻¹ capacity at 1 C after 300 cycles.

### Example 6: Na Metal Battery Electrochemical Data

Defect rich and N-doped PDC material is expected to be promising host materials for Na plating/stripping as it has ample sodiophilic sites. Accordingly, Na plating/striping experiments were performed using PDC material to establish the connection between surface properties and Na deposition in half-cell. Initially, capacity was kept constant and current density was varied. In later experiments, current density was kept constant and capacity was varied. The nucleation overpotential, C.E. and cycle number are critical parameters to evaluate the sodiophilicity of the host material. At 2 mAcm⁻² current density and 2 mAhcm⁻² capacity, Na∥PDC1000 displayed over potential of 22 mV with C.E. of 99.93% after 150 cycles. Voltage vs. time curve of Na∥PDC1000 at 2 mAcm⁻² current density and 2 mAhcm⁻² capacity is shown in FIG. 7(a) and C. E. vs. cycle number data is shown in FIG. 7(b). At current density of 4 mAcm⁻² and capacity of 2 mAhcm⁻², Na∥PDC1000 displayed overpotential of 13 mV with C.E. of 98.56% after 250 cycles. Voltage vs. time curve of Na∥PDC1000 at 4 mAcm⁻² current density and 2 mAhcm⁻² capacity is shown in FIG. 7(a) and C.E. vs. cycle number data is shown in FIG. 7(b). When current density was increased to 6 mAcm⁻² with 2 mAhcm⁻² capacity, Na∥PDC1000 displayed overpotential of 7 mV with C.E. of 96.83% after 1000 cycles (FIG. 7 (c) and (e)). When capacity was increased to 4 mAhcm⁻² at 6 mAcm⁻² current density in Na∥PDC1000 cell, the voltage hysteresis is decreased to 8 mV and C.E. is 99.45% after 500 cycles (FIG. 7 (c) and (e)). Increased in the C.E and decreased in the polarization potential of PDC1000 at higher current and capacity is because it is a high rate and high capacity material pertaining to earlier explained structural properties. The Na∥PRC1000 cell shows the voltage hysteresis of 4 mV and C.E. is 99.95% after 80 cycles at 4 mAhcm⁻²_6 mAcm⁻² rate.

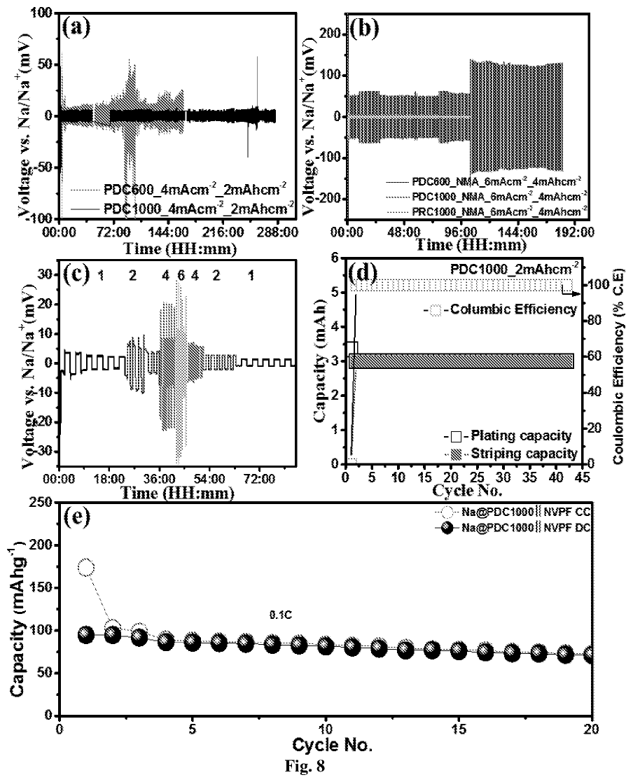

Furthermore, Na∥PDC1000 was compared with Na∥PDC600 at different plating/stripping parameters. Comparative voltage vs. time curve of PDC600 and PDC1000 is shown in FIG. 8(a) at 4 mAcm⁻² current density and 2 mAhcm⁻² capacity. At current density of 4 mAcm⁻²_2 mAhcm⁻², Na∥PDC600 displayed overpotential of 47 mV with C.E of 98.5% after 160 cycles whereas Na∥PDC1000 displayed overpotential of 13 mV with C.E of 98.5%. The overpotential is higher in Na∥PDC600 in comparison to Na∥PDC1000 and voltage profile fluctuating in Na∥PDC600 was also high in comparison to Na∥PDC1000 which showed stable voltage vs. time curve. The plating/stripping voltage vs. time curve of Na∥PDC600 and Na∥PDC1000 is also compared at 6 mAcm⁻² current density and 4 mAhcm⁻² capacity (FIG. 8b). At current density of 6 mAcm⁻²_4 mAhcm⁻², Na∥PDC600 displayed overpotential of 101 mV with C.E of 99.71% after 140 cycles whereas Na∥PDC1000 displayed overpotential of 8 mV with C.E of 99.5%. At these parameters as well, overpotential is higher in Na∥PDC600 in comparison to Na∥PDC1000 with unstable voltage profile. This is because of larger d-spacing between interlayers (more space to accommodate Na metal), more surface functional groups and defects, more pore volume and presence of pyrrolic and pyridinic N dopants in PDC1000 which have less energy barrier for Na. In contrast, PDC600 shows uneven Na plating/stripping performance. It may be because of less conductivity, fewer surface functional groups at surface and low mesoporous density. Non-uniform deposition can cause rupture of interface and instability. The rate performance of Na plating/stripping behaviour was studied at different current densities 1 mAcm⁻², 2 mAcm⁻², 4 mAcm⁻², 6 mAcm⁻² and 2 mAhcm⁻² capacity. Na∥PDC1000 exhibited stable C.E. up to 43 cycles at different current rates and could tolerate sudden change in current which indicates rapid reaction dynamics ((FIG. 8 (c) and (d))).

The Na∥PDC1000 materials showed stable plating/stripping with enhanced C.E. when capacity was increased at higher current rates and C.E. is also better. It indicates that PDC100 has higher Na storage capacity. Similar behaviour is obtained when PDC1000 was tested as NIB anode at higher currents. Subsequently, full cell of Na@PDC1000 and NVPF was fabricated and tested at 0.1 C current rate. Na@PDC1000∥NVPF full cell exhibit capacity of 98 mAhg⁻¹ at 0.1 C rate after 25 cycles (FIG. 8 (e)).

### Comparative Example 1

The below table compares the biphasic Nitrogen doped sodiophilic anode containing cell of present invention over literature known materials:

TABLE 2
Comparison of electrochemical performance of different carbon materials in NMBs

| | | Current | | | | | |
|---|---|---|---|---|---|---|---|
| | | density | Capacity | Cycle | Over | | |
| S. | | (mA | (mAh | number/ | potential | | |
| No. | Material | cm⁻²) | cm⁻²) | time | (mV) | C.E. | Reference |
| 1 | S-CNT | 0.5 | 2 | 2500 | 6 | 99.8 | ACS Appl. Energy |
| | | | | | | | Mater. 2018, 1, 5, 1846- |
| | | | | | | | 1852 |
| 2 | N,S- | 1 | 1 | 270 | 20 | 99.8 | Adv. Mater., 2018, 30, |
| | CNT | | | | | | 1801334 |
| 3 | VG/CC | 10 | 2 | 100 | 90 | 99 | Frontiers in Chem, |
| | | | | | | | 2019, 7, 1-11 |
| 4 | 3D | 2 | 1 | 650 | 17.8 | 99 | J. Mater. Chem. A, |
| | rGO/ | | | | | | 2020, 8, 19843-19854 |
| | CNT | | | | | | |
| 5 | 3D | 1 | 1 | 250 | — | 99 | ACS Appl. Energy |
| | printed | | | | | | Mater., 2019, 2, 3869- |
| | graphene | | | | | | 3877 |
| 6 | PDC | 6 | 4 | 600/560 h | 8 | 99.45 | Present Work |

The above mentioned literature strategies (summarized in table 2) such as doping, co-doping into carbon, morphology engineering and sodiophilic seeds have been investigated to plate sodium uniformly. The present invention PDC outperforms these materials in terms of capacity (Na deposition) at higher plating/stripping rates, coulombic efficiency (CE) and cycle number. The effectiveness of PDC for plating/stripping is because of biphasic nature, higher d-spacing and heteroatom doping. Low cost and scalability are other added advantages of PDC.

### Advantages of the Invention

Partial graphitization, biphasic nature, heteroatom doping, surface functional group and large interlayer d-spacing play critical role in Na storage.
Large interlayer d-spacing provides and N-doping account for high rate capability.
Co-existence of amorphous and graphitic domains can provide more interlayer space for Na storage as well as conductivity.
Heteroatom doping channels uniform nucleation and guided Na plating/stripping behavior.
Recycling of polymer waste was done so it is a cheap precursor for anode synthesis. Invariability of precursor can be addressed as polymer composition does not depend on location as in biomass.
Provides sustainable and energy-efficient way to solve energy and environmental issues and obtain sodiophilic material which is defect rich and N-doped.

1. A biphasic nitrogen doped sodiophilic anode comprising a defect rich nitrogen doped polymer derived carbon (PDC) and/or commercial polyvinyl based polymer derived carbon (PRC) plated with sodium;
wherein BET surface area of the anode is in the range of 40 m²g⁻¹ to 80 m²g⁻¹ and pore volume of the anode is in the range of 0.041 cm³/g to 0.63 cm³/g.

2. The anode as claimed in claim 1, wherein the polymer is selected from waste plasticized polyvinyl based polymer packaging material (P-PVPP) or commercial poly vinyl based polymer.

3. A process of preparing the biphasic nitrogen doped sodiophilic anode as claimed in claim 1 comprising the steps of:
a) cleaning a waste plasticized polyvinyl based polymer packaging (P-PVPP) material to obtain a first processed material;
b) removing an aluminium layer from the first processed material obtained in step (a) to obtain a second processed material;
c) cutting the second processed material obtained in step (b) and/or commercial poly vinyl based polymer into a small piece;
d) pyrolyzing the small pieces obtained in step (c) under a temperature in the range of 600-1000° C. for a period in the range of 4 h to 6 h under inert atmosphere with 5° C. min⁻¹ ramp rate and subsequently cooling by natural convection to obtain a pyrolyzed material;
e) washing the pyrolyzed material obtained in step (d) with acid and distilled water to obtain a washed pyrolyzed material;
f) drying the washed pyrolyzed material obtained in step (e) at a temperature in the range of 70-90° C. overnight for 8-12 h in an oven to obtain the defect rich N-doped waste polymer derived carbon (PDC) and/or polyvinyl based polymer derived carbon (PRC); and
g) applying said N-doped waste polymer derived carbon (PDC) and/or polyvinyl based polymer derived carbon (PRC) onto a conventional anode to obtain the biphasic nitrogen doped sodiophilic anode.

4. The process as claimed in claim 3, wherein the conventional anode is selected from carbon based material, alloy-based material, and a 2D material.

5. The process as claimed in claim 4, wherein the carbon based material is selected from graphite, carbon nanosheets, hard or soft carbon, hollow carbon, carbon nanospheres, carbon microtubes, and amorphous carbon; wherein alloy in the alloy based material is selected from Si, Ge, Sn, Pb, P, and Sb; and wherein the 2D material is graphene or reduced graphene oxide.

6. The process as claimed in claim 3, wherein the cleaning in step a) is done by cleaning the waste P-PVPP material with deionized water followed by drying at a temperature in the range of 70-100° C.

7. A sodium ion/metal battery cell comprising:
a biphasic nitrogen doped sodiophilic anode as claimed in claim 1;
a cathode;
an electrolyte; and
a separator.

8. The battery cell as claimed in claim 7, wherein the cathode is selected from the group consisting of Na₃V₂(PO₄)₂F₃ (NVPF), Prussian blue analogue Na₂Fe[Fe(CN)₆] and Prussian white analogue Na_{1.88}Fe[Fe(CN)₆]×0.7H₂O.

9. The battery cell as claimed in claim 7, wherein the cathode is Na₃V₂(PO₄)₂F₃ (NVPF).

10. The battery cell as claimed in claim 7, wherein the electrolyte is selected from the group consisting of 1M NaPF₆ in ethylene carbonate (EC)/diethylene carbonate (DEC) with an additive selected from NaF and SnF₂.

11. The battery cell as claimed in claim 7, wherein the separator is selected from microporous glass fiber and celgard.

12. The battery cell as claimed in claim 7, wherein the anode is non-presodiated or pre-sodiated, wherein the pre-sodiation is done by coating or spraying of solution containing Na-metal and coating of Na-complexes selected from Na-biphenyl and Na-naphthalene onto the anode surface to compensate sodium loss in surface electrolyte interphase (SEI).

13. The battery cell as claimed in claim 7, wherein the cathode is non-presodiated or pre-sodiated, wherein the pre-sodiation is done by coating or spraying of the solution of sodium citrate, sodium mesoxalate (SMO) and Na₂S onto the cathode surface to compensate loss in surface solid electrolyte interphase (SEI).
